(19) United States
(12) Patent Application Publication
(10) Pub. No.: US 2007/0207634 A1
(43) Pub. Date: Sep. 6, 2007

(54) Method For Mounting A Circuit Support In A Housing, Circuit Module, Housing And Clamping Element

(75) Inventors: Thomas Maurer, Regensburg (DE); Karl Smirra, Wasserburg (DE)

Correspondence Address: LERNER GREENBERG STEMER LLP, P O BOX 2480, HOLLYWOOD, FL, 33022-2480, US

(73) Assignee: Siemens Aktiendgesellschaft

(21) Appl. No.: 11/547,498

(22) PCT Filed: Mar. 11, 2005
(86) PCT No.: PCT/EP05/51116

§ 371 Date: Oct. 2, 2006

(30) Foreign Application Priority Data
Apr. 1, 2004 (DE) 10 2004 016 168.2

(51) Int. Cl. H01R 12/00

(52) U.S. Cl. 439/71

(57) ABSTRACT

A clamping element with an elliptical cross-section is introduced in a lying position between a circuit board and a housing, for fixing the circuit board in the housing. The clamping body is clamped by rotation in a vertical position between the circuit board and housing.

The invention relates to a method for mounting a circuit support in a housing, wherein the circuit support is inserted into the housing and is subjected to spring force by means of a clamping element.

The invention further relates to a circuit module, a housing and a clamping element.

U.S. Pat. No. 3,258,649 discloses such a method as well as a circuit module, a housing and clamping element. The known housing serves to accommodate a circuit board. To fix the circuit board in the housing, helical tension springs are provided which in the mounted state are disposed with the longitudinal axis parallel to the circuit board. For mounting the circuit board in the housing the circuit board is first inserted into the housing. The spiral tension springs are then loaded and subsequently inserted, in the loaded state, between circuit board and housing. When the helical tension spring is at the specified location, the helical tension spring is unloaded, whereupon the helical tension spring tightens and expands in the transverse direction so that the circuit board is subjected to spring force.

A disadvantage of the known method and known circuit module is that inserting the loaded helical tension springs is a laborious process, said springs having to be held under tension at both ends simultaneously and inserted in the loaded state into the interspace provided for the purpose between housing and circuit board.

Proceeding from this prior art, the object of the invention is therefore to specify an easily implementable method for mounting a circuit support in a housing. A further object of the invention is to create an easily mountable circuit module. A final object of the invention is to provide a suitable housing and a clamping element for implementing the method.

These objects are achieved by a method, a circuit module as well as a housing and a clamping element having the features set forth in the independent claims. Advantageous embodiments and developments are described in claims dependent thereon.

For the method for mounting the circuit module, a clamping element contrived to rotate about a longitudinal axis and having different cross-sectional dimensions is first inserted horizontally between the circuit support and the housing. The clamping element is then clamped in place by swiveling it about the longitudinal axis into an upright position between circuit support and housing.

The circuit module can be mounted in a simple manner, as the clamping element only needs to be held at one end for insertion into the interspace provided for the purpose between housing and circuit support. The clamping element can then be placed in the clamping position by simply rotating it. For this purpose it is likewise only necessary to act on one end of the clamping element.

In a preferred embodiment of the circuit module, the housing of the circuit module is implemented rigidly and the clamping element itself resiliently. The advantage of this embodiment is that the housing can be implemented robustly, so that there is little or no deformation of the housing when external forces are exerted on the housing.

It is also possible to implement the clamping element in a rigid manner and the housing at least in sections in a resilient manner. In this case particularly large spring forces can be applied to hold down the circuit support.

In order to fix the clamping element in its upright position, recesses can be provided in the housing which are complementary to the clamping element in its upright position and by means of which the clamping element is secured in the upright position.

In a further preferred embodiment, the clamping element has an elliptical cross-section, enabling the clamping element to be easily placed in the upright position. In addition, the spring force on the circuit support increases only gradually during rotation, so that any deformation processes can take place slowly.

The clamping element can also exhibit, along the longitudinal axis, a region of reduced cross-section by means of which additional space is freed up for components on the circuit support.

Further features and advantages of the invention will emerge from the following description in which exemplary embodiments are individually explained in greater detail with reference to the accompanying drawings in which:

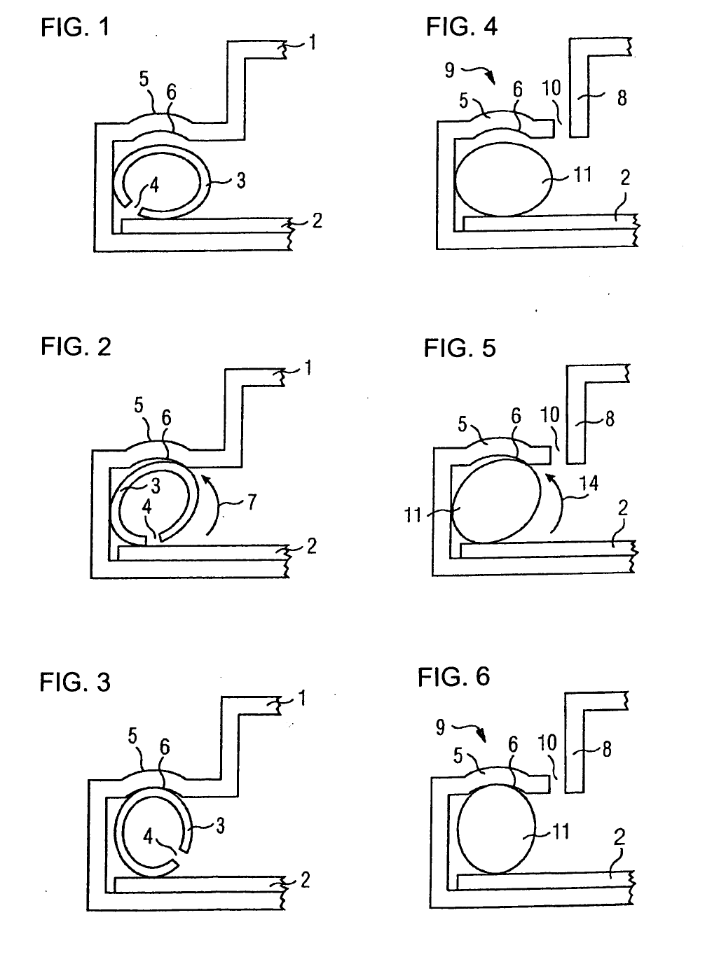

FIG. 1 shows a cross-section through a housing section with the clamping element horizontal;

FIG. 2 shows a cross-section through the housing section from FIG. 1 with the clamping element already partially rotated;

FIG. 3 shows a cross-section through the housing section from FIGS. 1 and 2 with the clamping element upright;

FIG. 4 shows a cross-section through a housing section of another resilient housing with the clamping piece horizontal;

FIG. 5 shows the housing section from FIG. 4 with the clamping piece partially rotated;

FIG. 6 shows the housing section from FIGS. 4 and 5 with the clamping piece in the upright position;

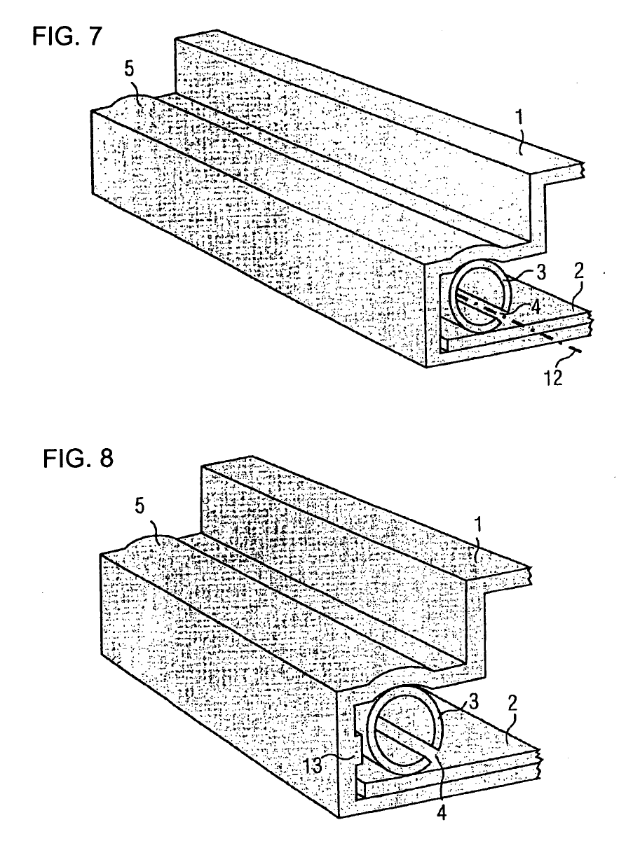

FIG. 7 shows a perspective view of a housing section according to FIGS. 1 to 3;

FIG. 8 shows a perspective view of part of another modified housing; and

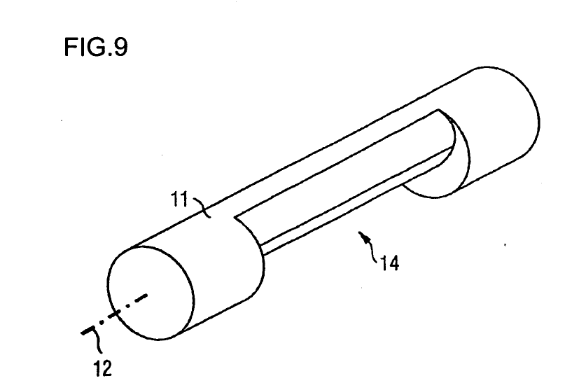

FIG. 9 shows a perspective view of a clamping element with a central region of reduced cross-section.

FIG. 1 shows part of a cross-section through a housing 1 into which a circuit board 2 is inserted. The housing 1 can be e.g. an extruded shape. Above the circuit board 2 there is located a clamping piece 3 which has an elliptical cross-section. The clamping piece 3 is preferably bent from a spring plate, said spring plate not necessarily having to form a closed shape, but also possibly being broken by a gap 4. In the region of the clamping piece 3, the housing 1 has a convexity 5. Correspondingly the housing 1 has on its inner side a concavity 6 whose function will be explained in greater detail below.

In FIG. 2 the clamping piece 3 has been rotated in the direction of an arrow 7 and bears against both the housing 1 and the circuit board 2.

By rotating the clamping piece 3 further in the direction of the arrow 7, the clamping piece 3 is moved to the upright position illustrated in FIG. 3 in which the clamping piece 3 engages with its upper end in the concavity 6 in the housing 1 and bears against the circuit board 2 with its lower end. In this position the clamping piece 3 exerts spring pressure on the circuit board 2, thereby fixing the circuit board 2 in the housing 1.

The circuit module comprising the circuit board 2 and the housing can be mounted in a simple manner. First the circuit board 2 is inserted in the housing 1. Then the clamping piece 3 is slid in between housing 1 and circuit board 2 in the horizontal position illustrated in FIG. 1. By performing the rotation illustrated in FIG. 2, the clamping piece 3 can finally be placed in the upright position illustrated in FIG. 3. In the upright position, the clamping piece 3 is fixed in place by the concavity 6. No other securing means are therefore required to anchor the clamping piece 3 in position.

FIG. 4 shows part of a cross-section through another housing 8 into which the circuit board 2 can likewise be inserted. The housing 8 has a spring section 9 which is formed e.g. using a cutout 10. This housing 8 also can be made from an extruded shape.

To anchor the circuit board 2 in the housing 8 there is provided a clamping piece 11 which is implemented in a rigid manner in the example illustrated in FIG. 4.

As shown in FIG. 5, the clamping piece 11 can be rotated in the direction of the arrow 7 to the upright position illustrated in FIG. 6. In the upright position, a lower end of the clamping piece 11 rests on the circuit board 2, whereas an upper end of the clamping piece 11 engages in the concavity 6 in the spring section 9 and presses against the spring section 9 of the housing 8.

FIG. 7 shows a perspective view of part of the housing 1 shown in cross-section in FIGS. 1 to 3. It can be seen from FIG. 7 that the clamping piece 3 extends along a longitudinal axis 12 and exerts spring force on the circuit board 2 over a large area.

It should be noted that the clamping pieces 3 and 11 can be rotated in the direction of the arrow 7 by tools attached at either end of the clamping pieces 3 and 11. In the case of the clamping piece 3, for example, this can be a tool which engages in the gap 4 in the clamping piece 3.

To support rotation, additional guide elements can be implemented on the housing 1 or 8. FIG. 8 shows, by way of example, a modified embodiment of the housing 1 in which the clamping piece 3 is supported during rotation by a lateral projection 13. This ensures that the clamping piece 3 executes the rotation at the intended location and, in its upright position, engages in the concavity 6 in the housing 1. Additional guide elements (not shown) can ensure that the clamping piece 3 does not deflect onto the circuit board 2 and damage inserted components.

FIG. 9 finally shows a variant of the clamping piece 11 which exhibits a cross-sectional reduction in a central region along the longitudinal axis 12. In the example of the clamping piece 11 shown in FIG. 9, the cross-sectional reduction is accomplished by a central recessed region 14, thereby freeing up space for additional components on the circuit board 2 which can be disposed in the vicinity of the recessed region 14.

The hereinabove described mounting of the circuit board 2 in the housings 1 and 8 using the clamping pieces 3 and 11 provides a number of advantages. For example, the clamping pieces 3 and 11 can be produced in various lengths by cutting a shape to length. In this respect the clamping pieces 3 and 11 can be flexibly matched to the length of the housing 1. In addition, the circuit board 2 is pressed onto the intended bearing surface of the housing 1 or 8 along its entire length, so that heat is uninterruptedly transferred from the circuit board 2 to the housing 1 or 8 along the entire length of the circuit board 2. A further advantage is provided by the ease of mounting, the circuit board 2 also being easily removable from the housings 1 and 8. This is particularly advantageous if the circuit board 2 has to be repaired.

The circuit modules assembled according to the method described here are particularly suitable for accommodating transmission or engine control units, as the circuit board 2 is retained in the housings 1 and 8 in a vibration-proof manner.

1-15. (canceled)

16. A method of mounting a circuit board in a housing, the method which comprises:
inserting the circuit support into the housing;
providing a clamping element with different cross-sectional dimensions defining a lying orientation and an upright orientation of the clamping element;
inserting the clamping element between the circuit support and the housing in the lying orientation; and
rotating the clamping element about a longitudinal axis and clamping the clamping element in the upright orientation between the circuit support and the housing.

17. The method according to claim 16, which comprises providing a resilient clamping element and a rigid housing.

18. The method according to claim 16, which comprises providing a resilient housing and a rigid clamping element.

19. The method according to claim 16, which comprises, during the rotation of the clamping element, guiding a region of reduced cross-section in the clamping element past components disposed on the circuit board.

20. The method according to claim 16, which comprises providing the housing with a concavity having a shape complementary to the clamping element in the upright position thereof, and securing the clamping element by the concavity implemented in the housing.

21. A circuit module with a housing, comprising:
a circuit support disposed in the housing;
a clamping element formed with mutually different cross-sectional dimensions and disposed for rotation about a longitudinal axis from a lying position to an upright position, wherein said clamping element generates a spring force with clamping in the upright position between aid circuit support and the housing.

22. The circuit module according to claim 21, wherein said clamping element is a resilient clamping element and said housing is a rigid housing.

23. The circuit module according to claim 21, wherein said housing is a resilient housing and said clamping element is a rigid clamping element.

24. The circuit module according to claim 21, wherein said clamping element is formed with a central region of reduced cross-section along the longitudinal axis.

25. The circuit module according to claim 21, wherein said clamping element has a rounded cross-section.

26. The circuit module according to claim 25, wherein said clamping element has an elliptical cross-section.

27. The circuit module according to claim 21, wherein said clamping element is anchored in the upright position thereof by a concavity complementary in shape to one end of said clamping element.

28. The circuit module according to claim 21, wherein said housing includes guiding elements implemented therein, and a rotation of said clamping element is guided by said guiding elements.

29. A housing for a circuit support, which comprises a circuit support mounted inside the housing by the method according to claim 16.

30. A clamping element for mounting a circuit support, wherein the clamping element is configured for carrying out the method according to claim 16.
